(19) United States
(12) Patent Application Publication
(10) Pub. No.: US 2008/0014043 A1
(43) Pub. Date: Jan. 17, 2008

(54) PEG BOARD MOUNTING DEVICE

(76) Inventor: David Zasloff, Los Angeles, CA (US)

Correspondence Address: ST. ONGE STEWARD JOHNSTON & REENS, LLC, 986 BEDFORD STREET, STAMFORD, CT, 06905-5619, US

(21) Appl. No.: 11/777,493

(22) Filed: Jul. 13, 2007

Related U.S. Application Data
(60) Provisional application No. 60/830,523, filed on Jul. 13, 2006.

(51) Int. Cl. F16B 13/04; A47B 96/06

(52) U.S. Cl. 411/41; 248/220.31

(57) ABSTRACT

A mounting apparatus for securing to a perforated surface, including a bushing having a body portion from which a sleeve extends for insertion into a perforation, and a bore which extends through both the body and sleeve. The mounting apparatus also has a plunger that includes a head from which a stud extends. The bushing of the mounting apparatus is moveable from a first position to a second position. In the first position the sleeve of the bushing has a decreasing outer perimeter. In the second position the sleeve of the bushing is inserted into a perforation and the sleeve is radially expanded engaging the perforation by inserting the stud of the plunger into the bore of the bushing. When in the second position the apparatus has a mounting surface which extends away from the mounting surface. The mounting apparatus can further include a holding element and a magnetic element.

### CROSS-REFERENCE TO RELATED APPLICATIONS

This application claims priority benefits under 35 §U.S.C. 119(e) of the U.S. Provisional Application No. 60/830,523 filed on Jul. 13, 2006.

### FIELD OF THE INVENTION

The present invention relates to fasteners used to mount items to a perforated surface.

### BACKGROUND OF THE INVENTION

Fasteners are used to hold items on a perforated surface. The majority of fasteners sold comprise of hooks or loops (generally “hooks”) hanging off at least one hole in the surface. The way a hook is attached to the surface is usually via a bent rod which forms an offset portion at the top. This offset portion is inserted into the board using a rotating motion and once inserted the hook is allowed to hang from the hole, with the back of the hook resting upon the front surface of the wall.

One problem with this type of hook is that when an item is placed on the hook all its weight is supported by the bottom of a hole the hook is inserted into. This load causes these holes to become oblong or deformed over time and can lead to the hook not attaching to the board properly or the hole itself becoming so deformed it becomes more of a slot and therefore unusable. Another problem with these hooks is that they must hang off the hole causing one or more holes beneath the hole that the hook is inserted in to be covered by the hook itself or by an object hanging off the hook rendering the covered holes unusable.

Still another problem is that perforated boards can come in different thicknesses and having varying hole diameters. When hooks of uniform dimension are used they can fall off very easily when an item being held is removed by a user and the hook does not properly correspond to the hole size or board thickness.

What is desired, therefore, is a new and useful fastener for a peg board which does not deform the holes by transferring all the items weight to the bottom of the mounting hole, which allows the user to make use of the holes directly below the hanger by not resting over the hole below, which holds the item away from the surface of the board, that is removable from one hole for placement in a second hole and which will be able to adapt to the different manufacturing variations in board thickness and hole size and therefore, not easily fall off when removing items.

### SUMMARY OF THE INVENTION

These objectives are achieved by a mounting apparatus for securing to a perforated surface having at least one hole passing all the way through from a front surface to a rear surface. The mounting apparatus comprises a bushing having a body portion, a sleeve extending about an axis from the body in a distal direction for insertion into a perforation, and a bore that extends through the body and the sleeve about the axis. The mounting apparatus further comprises a plunger that comprises a head and a stud that extends from the head in a distal direction, wherein the head and the stud encompass a common axis. The bushing is moveable from: 1) a first position in which the outer surface of the sleeve comprises a decreasing outer perimeter in the distal direction; to 2) a second position in which the sleeve is inserted into the hole, the stud is inserted into the bore and radially expands the outer perimeter of the sleeve against the inner surface of the hole securing the bushing in the hole. When the bushing is in the second position, the mounting apparatus comprises a mounting surface that encompasses the axis of the bore, extends away from the front surface of the perforated surface and supports an item placed on the mounting surface in a direction parallel to the perforated surface.

It is another aspect of the invention for a flange to be disposed at the distal end of the sleeve and comprises an outer perimeter less than the inner perimeter of the at least one hole, which can be the smallest useable hole. The flange engages the rear surface of the perforated surface when the bushing is in the second position, securing the mounting apparatus to the perforated surface.

It is yet another aspect of the invention for the bore to have a distal bore region, an intermediate region, and a proximal bore region. The intermediate region comprises the minimum bore perimeter. The distal bore region is characterized by a gradually increasing inner perimeter in the distal direction that engages a trailing portion of an expanded tip at the distal end of the stud with a gradually increasing outer perimeter when the bushing is in the second position. The proximal bore region is characterized by a gradually decreasing inner perimeter in the distal direction that engages a leading portion of the expanded tip with a gradually decreasing outer perimeter as the expanded tip is inserted through the bore.

It is a further aspect of the invention for the body of the bushing to comprise a lip on the distal end of the body that receives a body spacer to be placed between the body and the perforated surface. The lip can encompass the axis of the bore and the body spacer can be an O-ring of compressible rubber like material.

It is still a further aspect of the invention for the bore to comprise a retainer towards the proximal end of the bore that extends towards the axis of the bore such that when the bushing is in a first position the inner perimeter of the bore at the retainer is smaller than a portion of the bore distally spaced from the retainer. The expanded tip is retained in the bore by the retainer when the bushing is in a first position.

It is another aspect of the invention for a holding element to be disposed on the mounting apparatus and extends away from the bore axis such that at least a portion of the mounting surface is disposed between the holding element and the perforated surface. The holding element can comprise an outer perimeter that encompasses the bore axis and is greater than the outer perimeter of the mounting surface. The holding element can also be secured to the proximal end of the plunger.

It is still another aspect of the invention for the portion of the mounting apparatus comprising the mounting surface to comprise a magnetic element. The magnetic element can be disposed in the holding element.

The present invention provides the benefits of using only one hole to attach to a perforated surface via a fastener that will hold all sides of the hole. Since the device has no need to hang off the hole, the hole directly below it will be available for use. If a user decided to hang an item below the fastener they would be able to use the hole directly below the one in use by either a conventional hook or another magnet with a lesser offset. This will allow users to maximize the useable space on the perforated surface. When a magnetic holding element is used, one item can be secured to the magnet and another item can hang from the mounting surface. Further, an item hung on the mounting surface can be more securely held on the mounting apparatus by the magnet. Still further, the invention enables the mounting apparatus to be removable so that the mounting apparatus can be moved from a first hole to a second hole.

Other aspects of the invention and its particular features and advantages will become more apparent from consideration of the following drawings and accompanying detailed description.

### BRIEF DESCRIPTION OF THE DRAWINGS

FIG. 1 is an exploded side view of the unassembled components of an embodiment of the plunger activated peg board fastening device.

FIG. 2 is a side sectional view of the expandable bushing of the embodiment of FIG. 1.

FIG. 3 is a bottom view of the expandable bushing of the embodiment of FIG. 1.

FIG. 4 is a perspective view of the expandable bushing of the embodiment of FIG. 1.

FIG. 5 is a perspective view of the plunger of the embodiment of FIG. 1.

FIG. 6 is an assembled view of the plunger activated peg board fastening device of the embodiment of FIG. 1.

FIG. 7 is a sectional view of another embodiment of the expandable bushing.

FIG. 8 is a perspective view of an embodiment of the plunger activated peg board fastening device mounted to a surface in the second position.

### DETAILED DESCRIPTION OF THE INVENTION

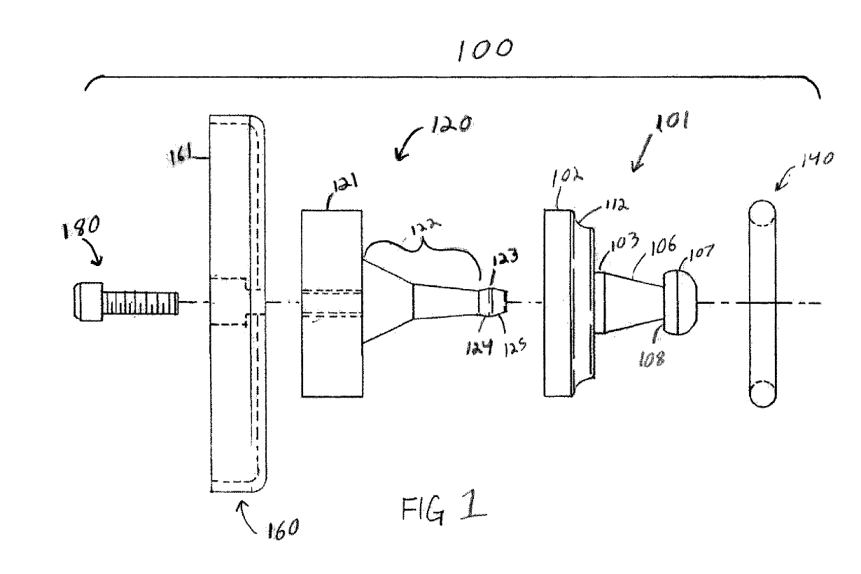

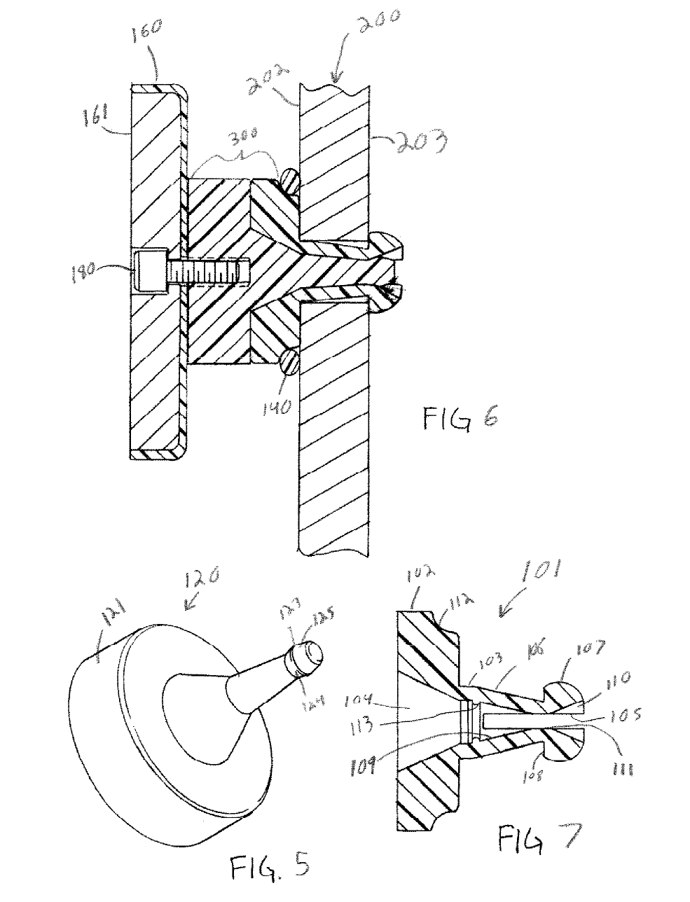

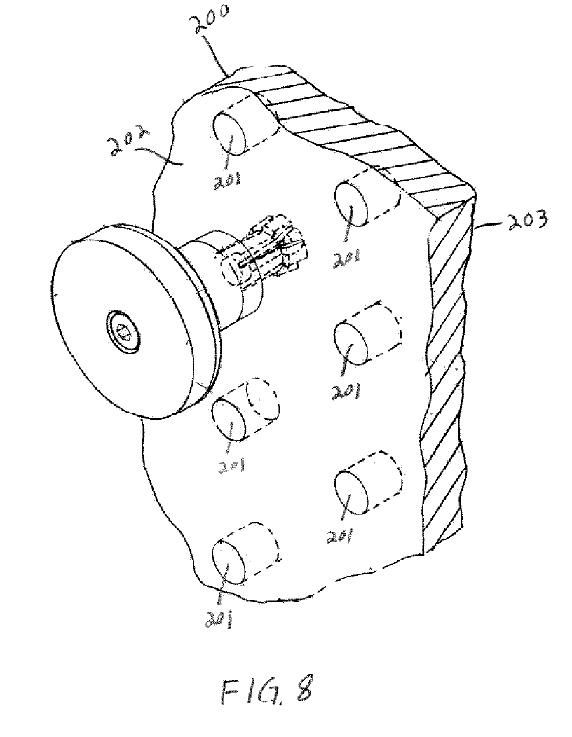

FIGS. 1-6 display the elements forming mounting apparatus 100. Mounting apparatus 100 comprises bushing 101 and plunger 120. Mounting apparatus 100 is used with a perforated board 200 having at least one hole 201, typically a plurality forming a pattern, that passes all the way through from a front surface 202 to a rear surface 203 of the board 200. Bushing 101 is inserted into a hole 201 in the board 200 and is locked in to the board 200 by receiving plunger 120 in a bore 104 that passes through the bushing 101.

Bushing 101 comprises a body portion 102 and sleeve 103. The body portion 102 comprises an outer perimeter that is greater than the size of the hole 201 in which the bushing 101 is to be mounted. Thus, when sleeve 103 is inserted in to the hole 201, a portion of body portion 102 is flush with the front surface 202 of the perforated board 200. Bushing 101 is moveable from: 1) a first position in which the outer surface of the sleeve 103 comprises a decreasing outer perimeter; to 2) a second position in which the sleeve 103 is inserted into a hole 201 of a perforated board 200, the outer perimeter of the sleeve 103 radially expands against the inner surface of the hole 201 securing the bushing in the hole 201. In order to promote the radial expansion of sleeve 103, the sleeve comprises slots 105 that form fingers 106. A flange 107 is disposed at the distal end of sleeve 103 and comprises an outer perimeter greater than the portion of sleeve 103 adjacent to flange 107. In order to assure that the bushing 101 can be received by holes 201 of different sizes, the outer perimeter of the flange 107 is typically less than the inner perimeter of the hole 201. FIG. 1 shows that the flange 107 has a donut shaped bulbous end. Flange 107 comprises a shoulder 108. When the sleeve 103 is inserted in to a hole 201 and the outer perimeter of the sleeve 103 is radially expanded, the shoulder 108 of the flange 107 engages the rear surface 203 of the perforated surface 200, securing the mounting apparatus to the perforated surface 200.

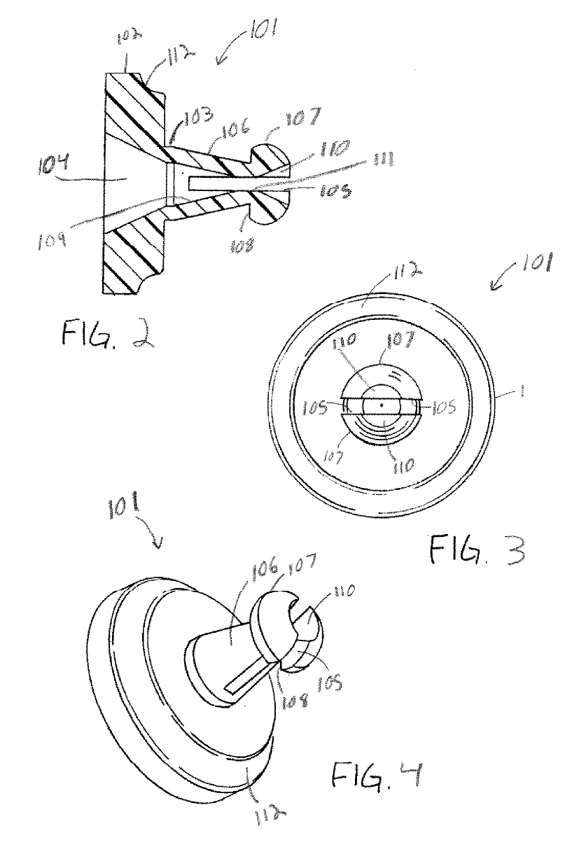

FIG. 2 shows bushing 101 comprising a bore 104 that extends through the body 102 and the sleeve 103. The bore 104 comprises a plurality of regions including a proximal bore region 109, distal bore region 110 and an intermediate region 111. The intermediate region 111 represents the minimum bore perimeter. The distal bore region 110 comprises a gradually increasing inner perimeter in the distal direction. The proximal bore region 109 comprises a gradually decreasing inner perimeter in the distal direction.

The body 102 of bushing 101 further comprises a lip 112. Lip 112 has an outer perimeter that is less than the outer perimeter of the body 102 and encompasses the axis of the bore 104. Lip 112 can receive a body spacer 140 such as an o-ring formed of a compressible rubber like material.

FIG. 7 shows bushing 101 with a retainer 113 in towards the proximal end of the bore 111. Retainer 113 extends towards the axis of the bore such that when the bushing is in a first position the inner perimeter of the bore at the retainer 113 is smaller than a portion of the bore distally spaced from the retainer.

Plunger 120 comprises a head 121 and a stud 122 that extends from the head 121. The head 121 and stud 122 encompass a common axis. An expanded tip 123 is disposed at the distal end of the stud 122 and comprises an outer perimeter greater than the portion of the outer perimeter of the stud 122 adjacent to the expanded tip 123. The expanded tip 123 comprises a trailing portion 124 with a gradually increasing outer perimeter in the distal direction. FIG. 1 shows that the trailing portion 124 forms a truncated conical part 124. The expanded tip 123 further comprises a leading portion 125 with a gradually decreasing outer perimeter in the distal direction. FIG. 1 shows that the leading portion 125 forms a truncated conical part 125. The diameter and length of the truncated conical parts 124, 125 are chosen to correspond to the dimensions of the proximal bore region 109 and distal bore region 110 respectively. The point at which these truncated conical parts 124,125 come together forms the maximum outer perimeter of the expanded tip 123.

In operation the bushing 101 is placed in a hole 201 of the perforated board 200 so that the sleeve 103 is disposed in the hole 201 and the flanges 107 are disposed beyond the rear surface 203 of the board 200. The expanded tip 123 and stud 122 of the plunger 120 are inserted into the bore 104 of the bushing 101. The expanded tip 123 is pressed through the proximal region of the bore 109. The leading surface 125 of the expanded tip 123 engages the surface of the proximal region 109 causing the sleeve 103 to radially expand. Once the expanded tip 123 passes the intermediate region of the bore 111, the intermediate region 111 engages the outer surface of the stud 122 and the sleeve 103 maintains a radially expanded state placing the bushing 101 in a second position. In the second position the flange 107 engages the rear surface 203 of the board 200 preventing the bushing 101 from being dislodged from the hole 201. The plunger 120 is secured in the bushing bore 104 by the trailing surface 124 of the expanded tip 123 engaging the distal region of the bore 110. As a result, both the bushing 101 and the plunger 120 are secured to the perforated board 200.

The orientation of trailing surface 124 relative to the orientation of the distal bore region 110 are designed such that the plunger and consequently the bushing are removable. By having sloping surfaces that correspond to one another, the plunger 120 can be moved in the proximal direction. Removal of plunger 120 from bore 104 permits the bushing 101 to be moved from the second position to the first position. This permits mounting apparatus 100 to be relocated from a first hole to a second hole.

As discussed above, perforated boards 200 can come in different thicknesses. If a thin board 200 is used, it may be beneficial to use a body spacer 140. FIG. 6 shows the cross section of an o-ring 140 placed about lip 112 of the bushing 101 such between the bushing body 102 and the front surface of the perforated board 202. The body spacer 140 provides an off-set that allows different board 200 thicknesses to be accommodated.

It would be beneficial for the bushing and plunger to be coupled together in both the first and second states. Such a combination could allow for securing the mounting apparatus 100 with a single hand and improve the efficiency of installing the mounting apparatus 100 on the perforated board 200. As discussed above, a retainer 113 can extend from the sleeve 103 in to the bushing bore 104. The retainer 113 can be effective for retaining a plunger already disposed in a bushing. With a retainer 113, the expanded tip 123 would already be disposed in the bore 104 in the distal direction relative to the retainer 113. The inner perimeter of the bore 104 at the retainer 113 would be less than the maximum outer perimeter of the expanded tip 123. As a result, the retainer 113 would prevent the expanded tip 123 from moving in the proximal direction keeping the plunger 120 coupled to the bushing 101.

With the bushing 101 and plunger 120 secured in the hole 201 a mounting surface 300 is formed upon which an item such as a tool can be hung. FIG. 6 shows that the mounting surface 300 is formed by the combination of the outer perimeter of the bushing body 102 and the plunger head 121. However, the mounting surface 300 could be formed solely by the outer perimeter of the plunger head 121 or the outer perimeter of the bushing body 102. The mounting surface 300 encompasses the axis of the bushing bore 104 and extends away from the front surface of the perforated board 202. FIG. 6 shows the mounting apparatus 100 comprising a holding element 160. The holding element 160 extends away from the bore 104 axis such that the mounting surface 300 is disposed between the holding element 160 and the front surface of the perforated board 202. The holding element 160 ensures that an item placed on the mounting surface 300 does not slide off. FIG. 6 also shows that the holding element 160 comprises an outer perimeter that encompasses the bore axis and is greater than the outer perimeter of the mounting surface 300.

In order to further secure an item to the mounting apparatus 100, the mounting apparatus 100 can include a magnetic element 161. FIG. 6 shows that a magnetic element 161 is incorporated in the holding element 160 and that the combination is attached to the proximal end of the plunger head 121 via a screw 180. It is also possible to secure the holding element 160 and magnetic element 161 to the plunger head 121 with glue or epoxy. The magnetic element 161 can be placed in the mounting surface 300 or coupled to another portion of mounting surface 300. The magnetic element 161 can be effective to ensure that an item placed on the mounting surface 300 is secured to the mounting apparatus 100. Further the magnetic element 161 can be used to place multiple items on the mounting apparatus 100. For instance, a screw driver can be placed on the front surface of the magnetic element 161 while a hammer is placed on the mounting surface 300. As a result the mounting apparatus 100 can improve the space efficiency of the perforated board 200.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A mounting apparatus for securing to a perforated surface having at least one hole passing all the way through from a front surface to a rear surface, comprising:
a bushing having a body portion, a sleeve extending about a bore axis from the body in a distal direction for insertion into a perforation, and a bore that extends through the body and the sleeve about the bore axis; and
a plunger that comprises a head and a stud that extends from the head in a distal direction, wherein the head and the stud encompass an axis;
wherein said bushing is movable from:
a first position in which the outer surface of the sleeve comprises a decreasing outer perimeter in the distal direction, to
a second position in which the sleeve is inserted into the hole, the stud is inserted into the bore radially expanding the outer perimeter of the sleeve against the inner surface of the hole to secure the bushing in the hole;
wherein the mounting apparatus with the bushing in the second position comprises a mounting surface encompassing the bore axis, extending perpendicular to the perforated surface and forming a support surface capable of supporting an item placed thereon.

2. The mounting apparatus of claim 1, wherein a flange is disposed at the distal end of the sleeve and comprises an outer perimeter greater than a portion of the outer perimeter of the sleeve.

3. The mounting apparatus of claim 2, wherein the outer perimeter of the flange is less than the inner perimeter of the at least one hole.

4. The mounting apparatus of claim 2, wherein the flange engages the rear surface of the perforated surface when the bushing is in the second position, securing the mounting apparatus to the perforated surface.

5. The mounting apparatus of claim 1, wherein the portion of the bore disposed in the sleeve comprises a plurality of regions including an intermediate region comprising a minimum bore perimeter.

6. The mounting apparatus of claim 5, wherein the portion of the bore disposed in the sleeve comprises a distal bore region distally spaced relative to the intermediate region, the distal bore region characterized by a gradually increasing inner perimeter in the distal direction.

7. The mounting apparatus of claim 6, wherein an expanded tip is disposed at the distal end of the stud and comprises an outer perimeter greater than a portion of the outer perimeter of the stud and a trailing portion with a gradually increasing outer perimeter in the distal direction, wherein the trailing portion engages the distal bore region of the bore when the bushing is in the second position.

8. The mounting apparatus of claim 7, wherein the orientation of the surface of the trailing portion relative to the orientation of the surface of the distal bore region are such that the plunger can be moved in the proximal direction moving the bushing from the second position to the first position.

9. The mounting apparatus of claim 5, wherein the portion of the bore disposed in the sleeve comprises a proximal bore region proximally spaced relative to the intermediate region, the proximal bore region characterized by a gradually decreasing inner perimeter in the distal direction.

10. The mounting apparatus of claim 9, wherein an expanded tip is disposed at the distal end of the stud and comprises an outer perimeter greater than a portion of the outer perimeter of the stud and a leading portion with a gradually decreasing outer perimeter in the distal direction that engages the proximal bore region as the expanded tip is inserted through the bore.

11. The mounting apparatus of claim 1, wherein the body of the bushing comprises a lip on the distal end of the body that receives a body spacer to be placed between the body and the perforated surface.

12. The mounting apparatus of claim 11, wherein the lip encompasses the axis of the bore.

13. The mounting apparatus of claim 12, wherein the body spacer is an O-ring of compressible material.

14. The mounting apparatus of claim 1, wherein the bore comprises a retainer towards the proximal end of the bore that extends towards the axis of the bore such that when the bushing is in a first position the inner perimeter of the bore at the retainer is smaller than a portion of the bore distally spaced from the retainer.

15. The mounting apparatus of claim 14, wherein an expanded tip is disposed at the distal end of the stud and comprises an outer perimeter greater than a portion of the outer perimeter of the stud, wherein the expanded tip is retained in the bore by the retainer when the bushing is in a first position.

16. The mounting apparatus of claim 1, wherein a holding element is disposed on the mounting apparatus and extends away from the bore axis such that at least a portion of the mounting surface is disposed between the holding element and the perforated surface.

17. The mounting apparatus of claim 16, wherein the holding element comprises an outer perimeter that encompasses the bore axis and is greater than the outer perimeter of the mounting surface.

18. The mounting apparatus of claim 16, wherein the holding element comprises a magnetic element.

19. The mounting apparatus of claim 16, wherein the holding element is secured to the proximal end of the plunger.

20. The mounting apparatus of claim 16, wherein the portion of the mounting apparatus comprising the mounting surface further comprises a magnetic element.

21. A tool mounting apparatus for securing to a perforated surface having at least one hole passing all the way through from a front surface to a rear surface, comprising:
a bushing for insertion into the at least one hole and a mounting surface with a magnetic element, wherein the mounting surface extends away from the front surface of the perforated surface when the mounting apparatus is inserted into the at least one hole.

22. The mounting apparatus of claim 21, wherein the magnetic element is disposed at the proximal end of the mounting apparatus.

23. The mounting apparatus of claim 21, wherein the bushing comprises a axis that aligns with the axis of the at least one hole when the bushing is inserted in to the hole and a holding element is disposed on the mounting apparatus and extends away from the axis such that at least a portion of the mounting surface is disposed between the holding element and the perforated surface.

24. The mounting apparatus of claim 23, wherein the holding element comprises an outer perimeter that encompasses the axis and is greater than the outer perimeter of the mounting surface.

25. The mounting apparatus of claim 23, wherein the holding element comprises the magnetic element.

26. The mounting apparatus of claim 23, wherein the holding element is secured to the proximal end of the mounting apparatus.
